(19) United States
(12) Patent Application Publication
(10) Pub. No.: US 2010/0035109 A1
(43) Pub. Date: Feb. 11, 2010

(54) Fuel cell systems with increased floor density

(75) Inventors: David Weingaertner, Sunnyvale, CA (US); Arne Watson Ballantine, Palo Alto, CA (US)

Correspondence Address: FOLEY AND LARDNER LLP;SUITE 500, 3000 K STREET NW, WASHINGTON, DC, 20007, US

(73) Assignee: BLOOM ENERGY CORPORATION

(21) Appl. No.: 12/222,294

(22) Filed: Aug. 6, 2008

(51) Int. Cl. H01M 8/10; H01M 8/04

(52) U.S. Cl. 429/30; 429/13

(57) ABSTRACT

A method of operating a fuel cell-based power generation system includes providing a plurality of fuel cell systems, each system including a plurality of fuel cell modules, and moving at least one fuel cell module of a fuel cell system with respect to a fuel cell module of another system.

### BACKGROUND OF THE INVENTION

The present invention relates generally to the field of fuel cell systems and more particularly to modular fuel cell systems and methods of operating the same.

### SUMMARY OF THE INVENTION

In one embodiment, a method of operating a fuel cell-based power generation system comprises (a) providing a plurality of fuel cell systems, each system comprising a plurality of fuel cell modules and (b) moving at least one fuel cell module of a fuel cell system with respect to a fuel cell module of another system.

In another embodiment, a fuel cell-based power generation system comprises a plurality of fuel cell systems, each comprising (a) a plurality of fuel cell modules, (b) a fuel processing module and (c) a housing, wherein at least one of the plurality of the fuel cell systems comprises at least one rail or wheel for displacing at least one fuel cell module of the at least one fuel cell systems with respect to a fuel cell module of another fuel cell system.

### BRIEF DESCRIPTION OF THE DRAWINGS

FIGS. 1A, 1B, 1C and 1D are illustrations of various arrangements for fuel cell systems in a fuel cell-based power generation system.

### DETAILED DESCRIPTION OF THE PREFERRED EMBODIMENTS

Fuel cell systems require a certain amount of floor space which can be interior or exterior (outside) space. The required floor space includes the space physically occupied by the fuel cell system itself and the open area immediately surrounding the fuel cell system which allows access for installation and maintenance. For fuel cell-based power generation systems employing a plurality of fuel cell systems, the amount of open area is considerable. As such, reduction of the open area around each fuel cell system leads to a significant increase in the net power density per unit floor area. To that end, the present embodiments describe methods for increasing the net power density per unit floor area of a fuel cell-based power generation system. In one aspect, the embodiments describe power generation systems in which at least some of a plurality of fuel cell systems are mobile. In a further aspect, at least some of a plurality of fuel cell modules of each system are mobile.

The fuel cell-based power generation system comprises a plurality of fuel cell systems each capable of independently producing power. Each fuel cell system comprises (a) a plurality of fuel cell modules, (b) a fuel processing/electronics/power conditioning module and (c) a housing. The fuel processing module may be separate from the electronics/power conditioning module. The fuel cell module comprises components, used for generating DC power from fuel and air streams, such as fuel cell stacks, balance of plant (BOP) components such as heat exchangers and optional reformers. Fuel cell stacks may be based on different fuel cell types. Non-limiting examples of high temperature fuel cell types include solid oxide and molten carbonate fuel cells. These fuel cells may operate using hydrogen and/or hydrocarbon fuels. There are also classes of fuel cells, such as the solid oxide regenerative fuel cells, that allow reversed operation, such that oxidized fuel can be reduced back to unoxidized fuel using electrical energy as an input. In the present embodiments, the preferred type of fuel cells are solid oxide fuel cells. Furthermore, each fuel cell module may comprise a separate housing. In each system, the fuel processing module comprises fuel processing equipment such as a desulfurizer and blower(s). The electronics/power conditioning components include DC/DC converters, DC/AC converters, etc.

A more extensive description of a fuel cell system comprising fuel cell modules and fuel a processing module(s) can be found in U.S. patent application Ser. No. 11/656,006, filed on Jan. 22, 2007, hereby incorporated by reference in its entirety.

In one embodiment, all fuel cell systems of a fuel cell-based power generation system are mobile. In another embodiment, at least some fuel cell systems of a fuel cell-based power generation system are mobile. The mobile fuel cell systems can be brought into a position closer to one or more other fuel cell systems to increase the net power density per unit floor area. When access to a system is required, such as for servicing a specific fuel cell system or module of the power generation system, the system may be moved to an open area position and then back when access is no longer required. Therefore, in one embodiment, a fuel cell module is mobile when it is part of a mobile fuel cell system. Alternatively, a fuel cell module may be mobile on its own, irrespective of whether the fuel cell system is mobile or immobile.

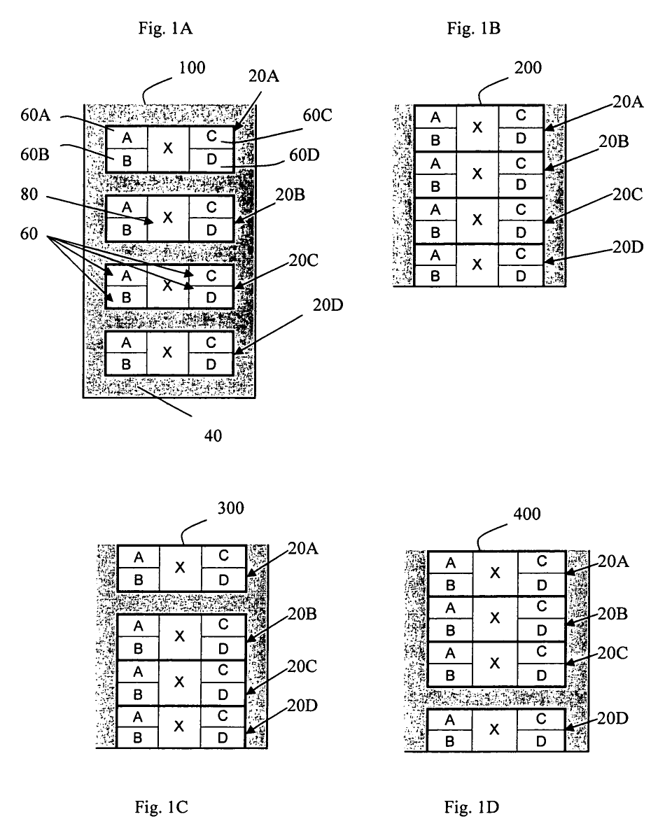

Examples of several arrangements for a fuel cell based power generation system are provided in FIGS. 1A-D, without any intent to limit the present embodiments to the same. In each of the four arrangements 100, 200, 300 and 400 shown in FIGS. 1A, 1B, 1C and 1D, respectively, the fuel cell-based power generation system comprises four fuel cell systems 20A, 20B, 20C and 20D, where the gray shade represents the open space 40 around each fuel cell system 20A-D. Each fuel cell system 20A-D comprises fuel cell modules 60A-D, in addition to fuel processing/electronics module(s) 80. Although FIGS. 1A-D illustrate linear arrangements, various non-linear, including circular arrangements for any one of the shown arrangements are also possible. Furthermore, there may be two, three or more than four fuel cell systems and each fuel cell system may contain two, three or more than four fuel cell modules such as eight to twelve fuel cell modules.

The first arrangement 100, shown in FIG. 1A, represents a traditional layout where each fuel cell system 20 and its fuel cell modules 60 are accessible at all times. This layout may be modified according to the present embodiments to mobilize at least one or all of the fuel cell systems using a mobility mechanism such as, but not limited to, rails (e.g., energized rails), wheels or a hoist. Each of the second 200, third 300 and fourth 400 arrangements shown in FIGS. 1B-D, respectively, comprise mobile fuel cell systems. Accordingly, the user may switch between any of the arrangements shown depending on the desired level of access. Preferably, the mobility mechanism allows the fuel cell system motion in the lateral, vertical or both directions while in operation. Also, preferably, the mobility mechanism does not interfere with forklift or pallet jack access.

In the second arrangement 200, shown in FIG. 1B, the fuel cell systems are mobile along their short dimension and are brought in close proximity with one another. Alternatively, the fuel cell systems may be mobile in a direction parallel to their long dimension. Once displaced, the fuel cell systems may or may not be in contact with one another. As shown, there is an increase in the net power density per unit floor area compared to the first arrangement. Stated differently, the net open amount of open floor space (gray shade) around a cluster of systems is reduced.

In certain cases, it may be desirable to arrange the fuel cell systems to allow access to only a few of the systems. In arrangement 300, shown in FIG. 1C, access is limited to the first and second systems, while in arrangement 400, shown in FIG. 1D, access is limited to the third and fourth systems. Alternatively, all systems 20A-D may be moved apart from each other as shown in FIG. 1A.

The mobile fuel cell systems may be rearranged during operation or non-operation. Specifically, the fuel cell systems may be relocated while in operation (i.e., while receiving fuel and air, and generating power (e.g. current)). Alternatively, the fuel cell systems may be relocated while receiving fuel and air, and operating at open circuit voltage (i.e., moving while consuming fuel and air but not generating power). In one embodiment, all utility connections such as, but not limited to, fuel, water, power are provided by a flexible conduit. The conduit may be made of a flexible material and/or may have and accordion-type collapsible structure. In another embodiment, a mobile fuel cell system comprises a fuel accumulator, such as a storage tank, for storing fuel. The accumulator is connected to the main fuel line through a quick-disconnect. Any suitable quick-disconnect mechanisms may be used such as snap on, screw on, tension type, etc. disconnects. Thus, this line need not be flexible as it may be disconnected to avoid hindering mobility of the fuel cell system. While the accumulator is disconnected from the main fuel line via the quick-disconnect, the accumulator moves with its respective fuel cell system.

In another embodiment, the power electronic components and/or fuel processing module of a fuel cell system are stationary while the fuel cell modules are mobile and set upon energized rails. In this manner, the fuel cell modules remain electrically coupled to the power electronics while mobile. One advantage of this design is that physical jumpers could be installed (and easily visible for debugging) to cross-connect the fuel cell modules to other positions on the power electronics.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A method of operating a fuel cell-based power generation system comprising:
providing a plurality of fuel cell systems, each system comprising a plurality of fuel cell modules; and
moving at least one fuel cell module of a fuel cell system with respect to a fuel cell module of another system.

2. The method of claim 1, further comprising moving one fuel cell system of the plurality of fuel cell systems with respect to another fuel cell system of the plurality of fuel cell systems.

3. The method of claim 1, further comprising servicing the at least one fuel cell module after the step of moving the at least one fuel cell module.

4. The method of claim 3, further comprising moving the at least one fuel cell module back to its original location after the servicing step.

5. The method of claim 2, further comprising providing fuel and air to at least one fuel cell system to generate power.

6. The method of claim 5, further comprising laterally or vertically moving the at least one fuel cell module while the module generates power.

7. The method of claim 1, further comprising laterally or vertically moving the at least one fuel cell module while the module is operating at open circuit voltage.

8. The method of claim 1, wherein the step of moving comprises moving the at least one fuel cell module using at least one wheel.

9. The method of claim 1, wherein the step of moving comprises moving the at least one fuel cell module using at least one energized rail.

10. The method of claim 1, further comprising providing fuel to at least one of the plurality of the fuel cell systems using a flexible conduit.

11. The method of claim 1, wherein at least one fuel cell system of the plurality of fuel cell systems comprises a fuel processing module and a plurality of fuel cell modules.

12. The method of claim 2, comprising moving a first housing with respect to a second housing, wherein said first and second housing each contain a separate fuel cell system.

13. A fuel cell-based power generation system comprising:
a plurality of fuel cell systems, each of the plurality of the fuel cell systems comprising:
a plurality of fuel cell modules;
a fuel processing module; and
a housing;
wherein at least one of the plurality of the fuel cell systems comprises at least one rail or wheel for displacing at least one fuel cell module of the at least one fuel cell systems with respect to a fuel cell module of another fuel cell system.

14. The system of claim 13, wherein at least one fuel cell system comprises at least one rail or wheel for displacing the entire fuel cell system with respect to another fuel cell system.

15. The system of claim 13, wherein the at least one fuel cell module further comprises a flexible conduit connecting at least one fuel cell module to a fuel or water supply.

16. The system of claim 13, wherein the at least one fuel cell system comprises a utility quick-disconnect.

17. The system of claim 16, wherein at least one fuel cell system further comprises a fuel accumulator coupled to a fuel source through the utility quick-disconnect.

18. The system of claim 13, wherein the plurality of fuel cell modules comprise solid oxide fuel cells.

19. The system of claim 13, wherein each of the plurality of fuel cell modules is located in a separate housing.

20. The system of claim 13, wherein the at least one fuel cell system comprises the at least one rail which is energized.

21. The method of claim 13, wherein the power generation system comprises a lift for vertical displacement of at least one fuel cell module.
